(19) United States
(12) Patent Application Publication
(10) Pub. No.: US 2005/0089147 A1
(43) Pub. Date: Apr. 28, 2005

(54) Knee x-ray cassette support

(76) Inventor: Vince Cantacessi SR., Scotts Valley, CA (US)

Correspondence Address: VINCE ROSARIO CANTACESSI SR., 702 PINECONE DR., SCOTTS VALLEY, CA, 95066, US

(21) Appl. No.: 10/944,113

(22) Filed: Sep. 20, 2004

Related U.S. Application Data
(60) Provisional application No. 60/514,798, filed on Oct. 27, 2003.

(51) Int. Cl. G03B 42/04; H01J 31/49; H01J 31/50

(52) U.S. Cl. 378/189

(57) ABSTRACT

A cassette support capable of holding several sizes of film cassettes, providing a frontal knee x-ray (Sunrise View) or side or rear view, without having the patient involved in holding the film cassette, as is commonly done now for the “sunrise view”, while lying in a supine position, sitting, or standing. The cassette (8) is supported across the patients body without the mast (2) touching the patient, as the support being flag shaped, extends the cassette over the patients leg behind the knee or in front of the knee ready for x-ray procedure. The simplicity of this design requires no set up of the cassette support as all it takes is placing it easily in position over the knee ready for x-ray, as compared to other methods that require complicated setting up procedures and taking more time.

### REFERENCES SITED

REFERENCES CITED
U.S. Pat. DOCUMENTS

| | | | |
|---|---|---|---|
| 3979595 | September 1976 | Merchant | 378/180 |
| 4700373 | October 1987 | Miller | 378/177 |

This non-provisional patent relies for priority date upon the provisional patent application filed by Vince Rosario Cantacessi Sr., entitled “KNEE X-RAY CASSETTE SUPPORT ,” application No. 60/514,798, filing date Oct. 27, 2003

### BACKGROUND OF THE INVENTION

An x-ray film cassette support that is used primarily for knee and joint x-rays, views of knee called “Sunrise View”, and also can be used for shoulders and any other parts of the body as this support is easily adaptable. The support is light, portable, fast and stable, can be used with patient lying or sitting with support located to the right or the left side of the patient. The cassette is set to the proper height of the patients knee when the leg is bent upwards, raising the knee slightly facing the x-ray machine, with the cassette located just behind the top of the knee, or in front of the knee facing the x-ray machine behind the patient lying below the beam of the x-ray. The cassette also is able to swivel 360 degrees to any angle sufficient to get the proper picture needed. This procedure eliminates what is Currently being done, that is, the patient is being asked to hold the cassette with both hands just behind the knee. This promotes vibration movement, holding the cassette at the wrong angles, and the technician taking the x-ray several times to take the right picture, especially with children and elderly patients who are in pain, nervous, have Parkinson's disease, or any other problems that would cause unsteady handling of the cassette. This support is simple, small and easy to use while patient is not involved with the x-ray procedure which will take less effort on every ones part.

### SUMMARY

A patent search revealed nothing like this support, as simple as it is as there are several knee platforms used for knee x-rays, but are large, cumbersome and takes more time and effort to adjust and use. My investigation of several hospitals revealed one platform type that was not being used because of the time it took to set up and use, instead they were having the patients hold the cassette as described above. This cassette support frees the patient from the responsibility of holding the film cassette in the proper position and being motionless at the same time, to produce an acceptable x-ray picture without having to retake the x-ray several times while being exposed to more radiation than needed.

### DESCRIPTION OF DRAWINGS

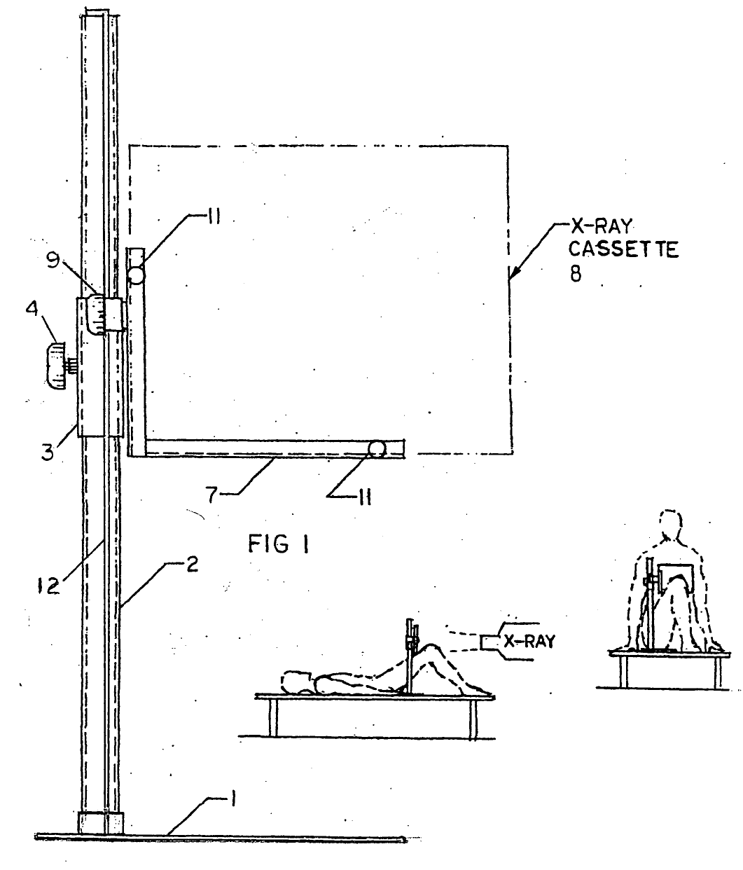

1. FIG. 1 is a front head on view showing the cassette located in the support, with views of the patient in lying and sitting positions for x-rays taken, as an example, in the rear of the knee, called “SUNRISE VIEW”

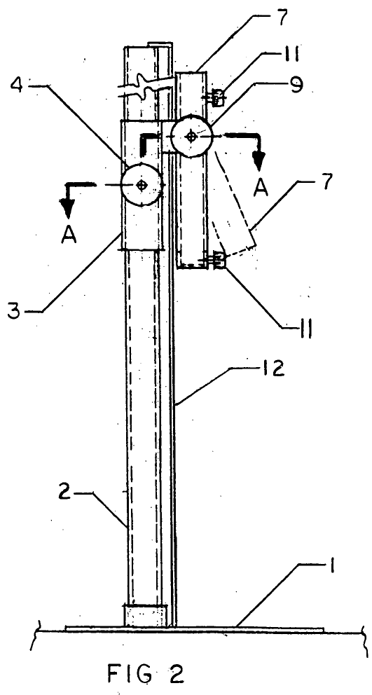

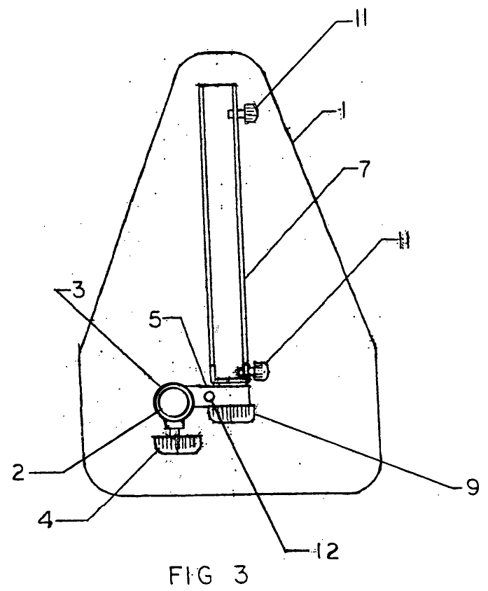

2. FIG. 2 shows the left elevation of the support showing the tilt option of the cassette and the section A-A location for the cross section views on page 4 of the drawing sheets, plus showing the knobs for height and tilt adjustments.

3. FIG. 3 shows the top view describing the base shape and location of the vertical mast (2) on the base.

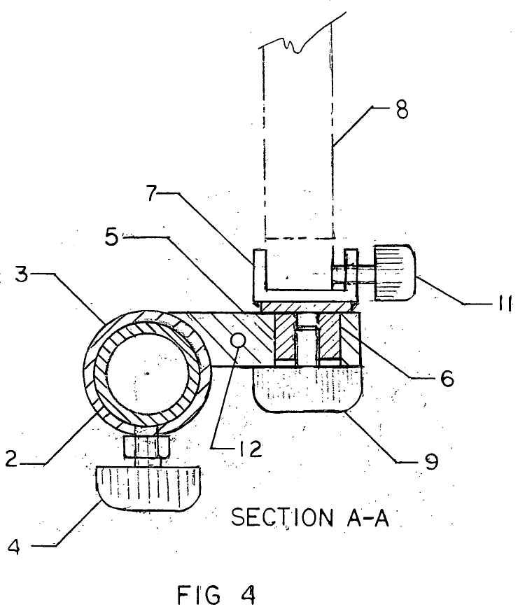

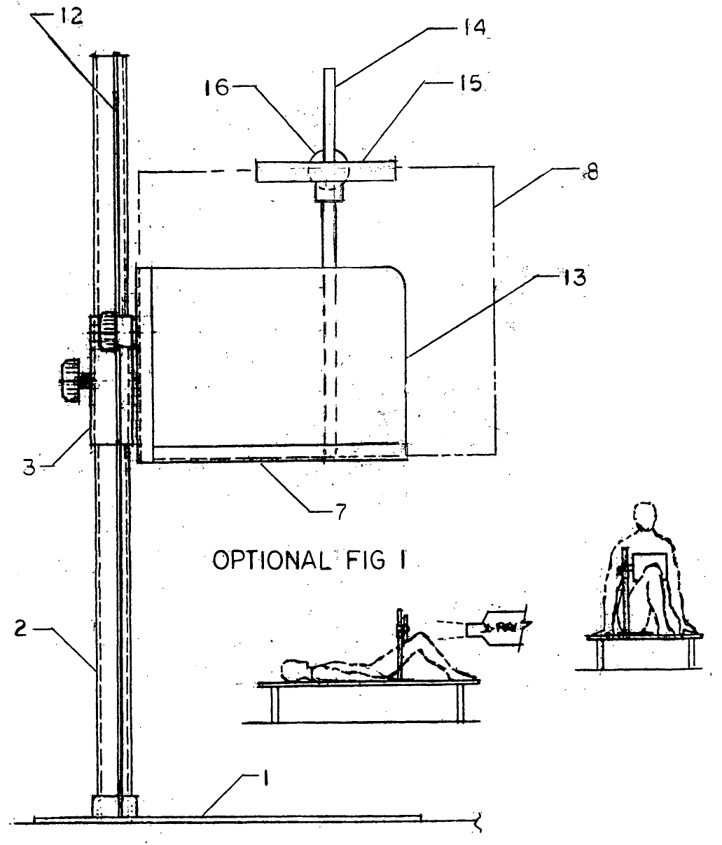

4. FIG. 4 shows the cross section view A-A

5. This invention is subject to modifications, different construction, and alternate materials which follow the scope and intentions of this invention.

### DESCRIPTION

This cassette support can be made of aluminum or stainless steel or any compatible material. It has a base (1) of wide thin material large enough to stabilize the support and not interfere with patient sitting near or on the base, and at the wide end of the triangular shaped base is mounted a hollow or solid, vertical, round or square mast (2). Along this mast slides an assembly (3) of larger diameter, or width, which can be raised or lowered in a vertical movement, easily and smoothly, to adjust to patients knee height, when standing, lying, or sitting. At that given height, a knob (4), or handle, on the assembly, can be turned to screw, or by any other means, against the vertical mast (2) to fix it at that given height.

On the assembly (3) is an extension (5) which has a close tolerance diameter hole to accept a close diameter rod (6) which can swivel as a slip fit smoothly with no loose wobble, which is attached to an L shaped combination of two channels (7) or any other suitable cassette holder, which support several sizes of x-ray film cassettes (8). In the center of the rod (6) is a tapped hole which will accept a threaded screw attached to a knob (9), or handle, to secure the L shaped channels at any angle (10) desired when knob (9) is tightened against the assembly extension (5), or by any other device to secure the proper angle.

In the L shaped combination of two channels (7) there are, at two locations, tapped holes in the wall of the channels, or in threaded nuts attached to the channels, to accept two small threaded screws with knobs (11) or by other means, to secure the cassette to the channel support. The support vertical mast (2) is offset from the center of the base to allow the L shaped channels, holding the film cassette to be centered over the patients leg without having the mast interfere against the patients body. The film cassette (8) would then be slid into the channels (7) and the two screw knobs (11) would then be tightened against the frame of the cassette securing it into position to be adjusted to the proper angle desired against the knee, either in front, behind, or to the side of the knee, ready for x-ray procedure.

In round mast assembly, a guide rod (12) is installed along side of the round mast (2) to guide assembly (3) thru a guide hole in assembly (3), in a vertical movement without letting assembly (3) swivel loosely around the mast (2). This keeps the cassette support channels (7) in a perpendicular position to the mast (2), letting the cassette stay in a fixed position over the patients leg behind the knee. or in front, or the side of the knee. The cassette would always be fixed in a flag shape, but always be free to be adjusted vertically.

Another round mast option is a plate (13) attached to the backside of the L shaped channels (7), and on the back side of the plate (13) is attached a round or square rod (14) of such length to allow for different sizes of film cassettes to be inserted using the rod (14) to support a clamp (15) which can slide vertically on the rod (14) clamping the top of the cassette down into the support channel (7). The clamp (15) would have a screw knob (16) to secure clamp to any height to accommodate different cassette sizes. This eliminates the use for item (11).

What I claim as my invention is:

1. A knee x-ray film cassette support for use with conventional x-ray machines compromising of:
A. Two channels combined together in an L shape to accept an x-ray film cassette of different sizes.
B. A means of securing said cassette to L shaped channels by screw knobs or clamp.
C. A swivel assembly connecting said L shaped channels to a vertical mast, allowing L shaped channels, containing film cassette, to be turned to any angle suitable for best x-ray picture.
D. An x-ray cassette support further including means of securing film cassette in a flag shaped position to be able to extend over the patients body behind his knee without interference of the vertical mast with the patients body.
E. An x-ray cassette support, further including means for adjusting the height of said L shaped channels along vertical mast, to accommodate for different knee heights.

2. A cassette support that does not need patient participation to hold the cassette with their hands in the position needed for front of knee view called “Sunrise View”.

3. An x-ray cassette support as in claim 2 which can be easily used on an x-ray table top and easily stored.
